(19) United States
(12) Patent Application Publication
(10) Pub. No.: US 2010/0082670 A1
(43) Pub. Date: Apr. 1, 2010

(54) MULTIPLE SEARCHING IN A WEB BROWSER INTERFACE

(75) Inventors: Ada Y. Chan, Santa Clara, CA (US); Steven J. Falkenburg, Los Altos, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/242,704

(22) Filed: Sep. 30, 2008

(51) Int. Cl. G06F 17/30

(52) U.S. Cl. 707/770; 707/E17.108; 707/E17.107

(57) ABSTRACT

Input is received from a user that indicates a selection of a hierarchical group of websites from a bookmark hierarchy in a web browser. In response, a modal dialog is opened to allow text input from the user. Text input is received via the modal dialog. The text input is supplied to each of the websites in the hierarchical group, causing each website in the group to produce a search result for the text input. Each of the search results is presented substantially simultaneously in a separate webpage associated with a respective website in the hierarchical group.

### FIELD

Embodiments of the invention relate to searches for data, such as searches for content through the internet.

### BACKGROUND

One of the most important and common functions of modern personal computers is providing access to and presenting Internet content. Internet content is typically provided and presented to users by means of an internet browser, such as SAFARI® made by APPLE® Inc., of Cupertino, Calif. or FIREFOX® made by MOZILLAE Corp., of Mountain View, Calif. or INTERNET EXPLORER® made by MICROSOFT® Corp., of Redmond, Wash.

The increasingly commonplace use of internet browsers and the concomitant growth in quality, quantity, and linkage of Internet content has led to new expectations regarding the ease of navigating the wealth of information found on the internet. With the increasing number of searchable websites, users of internet browsers have begun accessing internet content in new ways. Whereas users once used a single search engine or website to search for content, users are now more likely to use multiple search engines or website to search for content.

Some web browsers now provide a search tool as part of the browser toolbar that allows a user to enter search text and then select one of a plurality of search engines or websites from a dropdown menu to perform the search. The same or similar search text can be subsequently reused to search a different website selected from the dropdown menu. While this feature makes it easier to perform sequential searches on different search engines, it still only allows for a single search to be performed at any one time. Further, the results of each search can only be compared by clicking “back” and/or “forward” on the browser or by copying and pasting web links into new windows or tabs.

### SUMMARY OF THE DESCRIPTION

For a given input text string, multiple searches can be performed substantially simultaneously. The results of these searches can also be presented substantially simultaneously in different web pages in varying presentation formats. Input is received from a user that indicates a selection of a group (e.g. a hierarchical group) of websites from a bookmark hierarchy in a web browser. In response, a dialog is opened to allow text input from the user. Text input is received via the dialog. The dialog can be a modal dialog. The text input is supplied to each of the websites in the group, causing each website in the group to produce a search result for the text input. Each of the search results is presented by the web browser substantially simultaneously in a separate webpage associated with a respective website in the group.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a webpage having a search form.

FIG. 2 is a block diagram illustrating a dropdown menu in a web browser.

FIG. 3 is a block diagram illustrating multiple tabbed web pages in a web browser.

FIG. 4 is a block diagram illustrating a cover-flow display in a web browser.

FIG. 5 is a block diagram illustrating a plurality of web pages as widgets in a web browser.

FIG. 6 is a flow diagram illustrating a process for producing search results in a web browser according to various embodiments.

FIG. 7 is a block diagram illustrating a suitable computing environment for practicing various embodiments described herein.

### DETAILED DESCRIPTION

As provided herein, methods, apparatuses, and systems enable multiple website searches simultaneously based on a single text string input to a web browser. To be eligible for searching, a website (not the web browser) need only have a text field or “form” that allows a user to enter a text string and search the particular website. The text field or “form” may also be referred to herein a “text box” or “search box” or “search field.” “Text input” or “search string” or a “text string,” as used herein can include any combination of characters found on a computer keyboard, including letters, numbers, symbols, punctuation marks and the like. Of course, embodiments described herein are not limited to the entry of text from a computer keyboard. Any form of text input to a website is contemplated, including text input via a computer keyboard, a handheld device (e.g., PDA) or cell phone (e.g., smart phone) having web browsing functionality, etc.

Using a bookmark hierarchy in the web browser, a user may group together multiple websites into a bookmark folder. A user can maintain multiple folders in the bookmark hierarchy, each folder having links to a plurality of websites. Folders can be divided into subfolders and so on. For a selected folder or subfolder in the bookmark hierarchy, the associated dropdown menu provides an option to search all website in the folder or subfolder. By selecting this option, a modal dialog having a search box is opened which allows the user to enter a search string. A modal dialog (also known as a “modal window” or “dialog box”) is a child window or box presented by an application, in this case, a web browser. In some applications, a modal dialog requires a user to interact with it before workflow can be resumed. In other applications, modal dialogs do not necessarily freeze workflow. In other words, if a modal dialog is presented, the user may ignore it and continue interacting with other portions of the web browser or with other applications. It is not important in the various embodiments described herein whether or not a modal dialog freezes workflow.

The user may enter a search string into the search box of the modal dialog. When the browser receives this user input, the search string is sent to each of the respective websites in the selected group. All of the eligible websites (i.e., those that have a search feature built into the website) will produce a search result for the search string. Each of the search results is returned to the web browser which presents them each in a separate web page. In various embodiments, the presentation of each web page occurs substantially simultaneously. However, the results can be presented at different times (e.g., according to the different times that the results are returned to the web browser) in other embodiments.

The presentation of the multiple search results may be performed in a variety of ways by the web browser in various embodiments. In some embodiments, each of the different results may be presented in a different tab in the same window. In other embodiments, each result can be presented in a new window. Combinations of tabs and windows may also be used in various embodiments.

Additionally, the multiple search results may be presented in a “cover-flow” style according to the Cover Flow® presentation used in iTunes®, offered by Apple, Inc. of Cupertino, Calif. In such embodiments, each web page is displayed as part of the cover-flow in a way that is similar to the way multiple album covers are displayed in iTunes®. Thus, a user can flip through the web pages using the cover-flow to select a particular web page for viewing. When a web page is selected from a cover-flow lineup view, the web page is displayed, for example, in a full page view similar to the way a page might be displayed after selecting a tab from a group of tabs in a browser window.

In yet other embodiments, the multiple search results can each be displayed in a separate widget. Selecting a particular widget might open, for example, a full page view of the website. A widget, as used herein, may refer to any piece of code that can be installed and executed within any separate HTML-based web page by an end user with requiring additional compilation. Widgets may be visually detached from each other and/or from the web browser window(s).

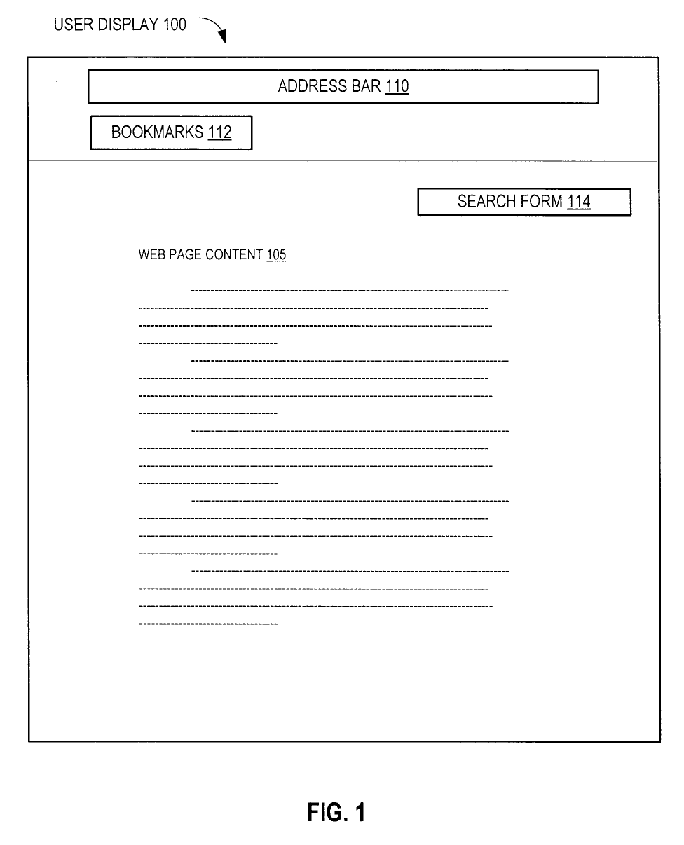

FIG. 1 is a block diagram illustrating a webpage having a search form. In a typical web browser, the user display 100 includes at least an address bar 110 for entering a Uniform Resource Locator (URL), one or more bookmark links 112, and a display of web content 105 associated with a particular web page. Increasingly, websites include a search form 114, which allows a user to enter a search string. The search string can subsequently be used to search one or more web pages associated with the website. For example, a particular website may have a main web page, which includes links to several other associated web pages whose addresses are extensions of the URL for the main page. Additionally, websites often referred to as “search engines” include a similar search form. Search engines, however, are often specifically designed to search web pages that are not directly associated with the search engine. For example, the Google™ search engine receives search strings as input and then searches the entire Internet for strings that match (partially or completely) the search string.

Search forms for various websites are embedded into the HTML code associated with those websites. Embodiments for performing multiple searches are facilitated by leveraging the “search form” HTML code. In other words, the web browser can supply a search string to any website that has an associated search form detected in the HTML code.

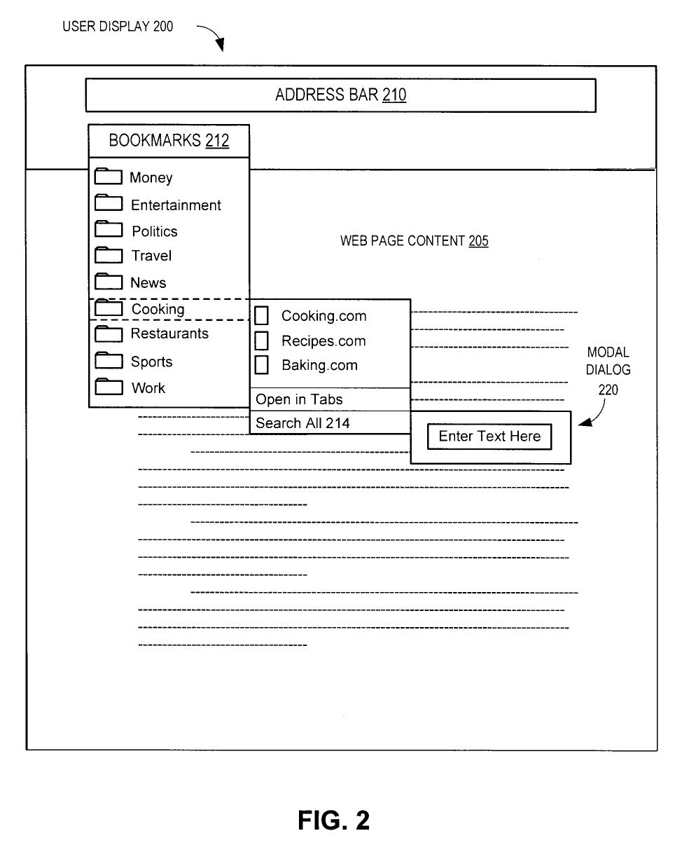

FIG. 2 is a block diagram illustrating a dropdown menu in a web browser. When a user selects (e.g., clicks) on bookmarks 212, a dropdown menu displays bookmark folders, as shown (individual web page links could also be displayed in the initial dropdown menu). The folders represent groups of bookmarks, categorized by a common theme or idea (e.g., music, travel, sports, etc.). As is known in the art, users can create bookmark folders for any collection of websites and/or web pages they might desire, regardless of theme or idea. In FIG. 2, the “cooking” folder is illustrated as including three websites related to cooking (cooking.com, recipes.com, baking.com). Some browsers have recently implemented a feature that allows a user to select (e.g., with a single mouse click) a dropdown item that opens all web pages of a folder in separate browser tabs.

In various embodiments, a new item 214 is added to a dropdown list for a folder of bookmarks. As shown, item 214 is labeled “Search All.” However, any other appropriately descriptive label could be used in other embodiments. The “Search All” item 214, when selected by a user, opens a modal dialog 220. As shown, modal dialog 220 may be visually attached to the dropdown menu. However, in other embodiments, modal dialog 220 can be visually detached from the dropdown menu.

A user may enter a search string into modal dialog 220. The web browser receives this input and feeds the search string to all of the web pages in the bookmarked folder from which the “Search All” item 214 was selected. Those websites and/or web pages in the folder that have a search form will be able to process the search string and generate a search result. For example, if a user entered the search string “apple pie,” each of the three cooking websites might generate a separate list of hits or results that relate to “apple pie” (e.g., recipes, discussions, etc.) In various embodiments, the web browser displays the results page for each of the three searches in a separate web page. In some embodiments, the separate web pages may be displayed substantially simultaneously.

Alternate embodiments may not require a modal dialog or text entry by a user at all. In some embodiments, a user could select (e.g., highlight) text on a web page and then perform an action (e.g., right-click with a mouse) that initiates a search request for the selected text. For example, if a user right-clicks on some highlighted text, a box or window might open that allows the user to select a group of websites (e.g., in a particular bookmark folder) to perform respective searches.

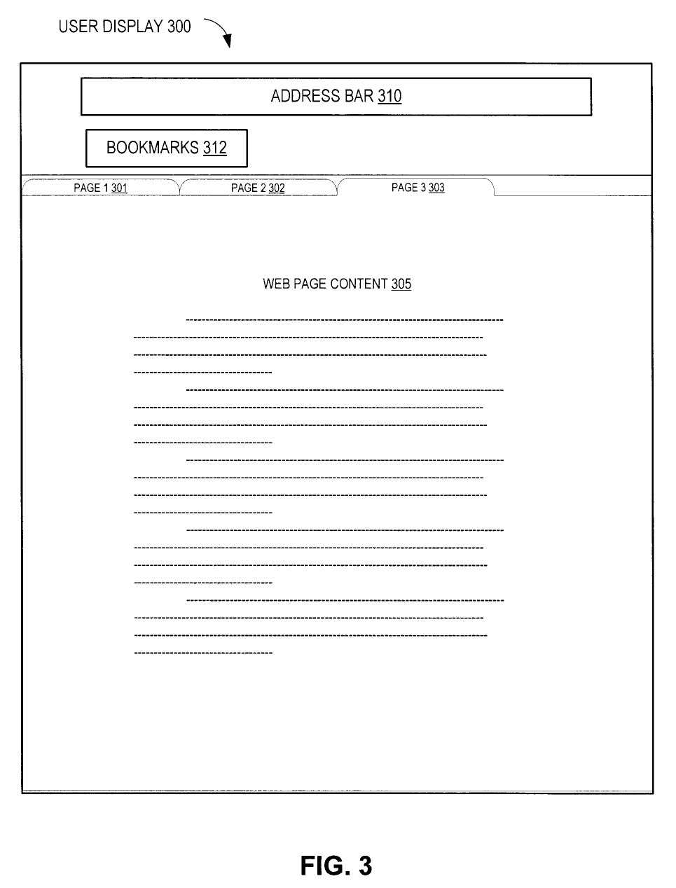

FIGS. 3-5 illustrate examples of browser displays for the multiple search results. In some embodiments, the multiple search results are displayed in separate tabs, for example, as illustrated in FIG. 3. So, using the example bookmarked pages from FIG. 2, the first page of search results (e.g., for cooking.com) might be displayed in tab 301. The second page (e.g., for recipes.com) might be displayed in tab 302. The third page (e.g., for baking.com) might be displayed in tab 303. Thus, by entering a single search string, the user automatically receives three separate search results, each in separate tabs on the web browser window. In some embodiments, the tabs could be in different browser windows. Additional search results (e.g., from subsequent searches) could be added as new tabs in a new browser window or an existing window.

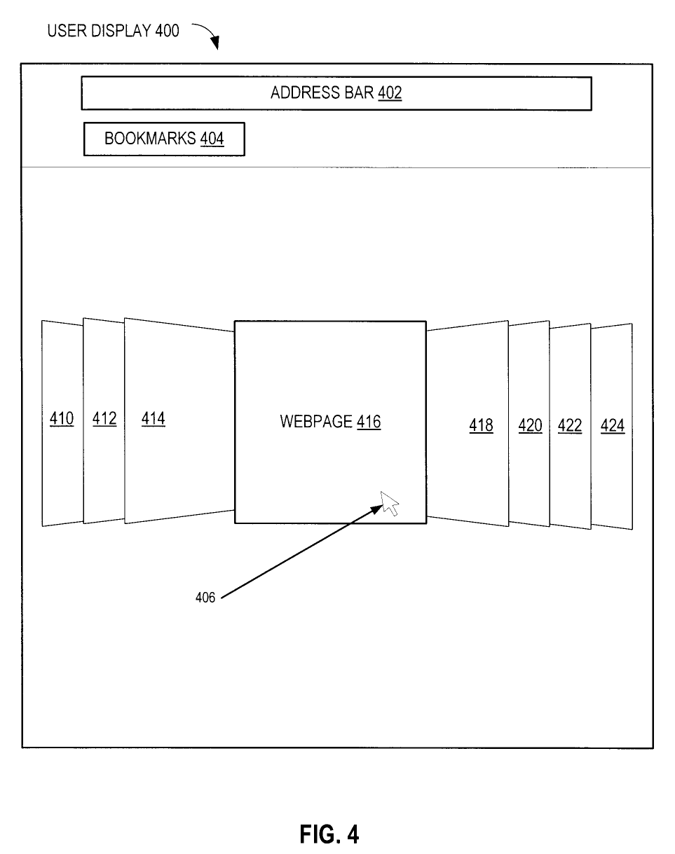

FIG. 4 is a block diagram illustrating a cover-flow display in a web browser. Again using the example from FIG. 2, the search results for each of the cooking websites might be displayed as album covers, for example, in covers 414, 416 and 418. Additional searches (using the same bookmark folder or using a different bookmark folder) could be added to the existing cover-flow, for example, in covers 410, 412, 420, 422, and/or 424. In various embodiments, a user can select any of the covers, for example, using a mouse pointer 406.

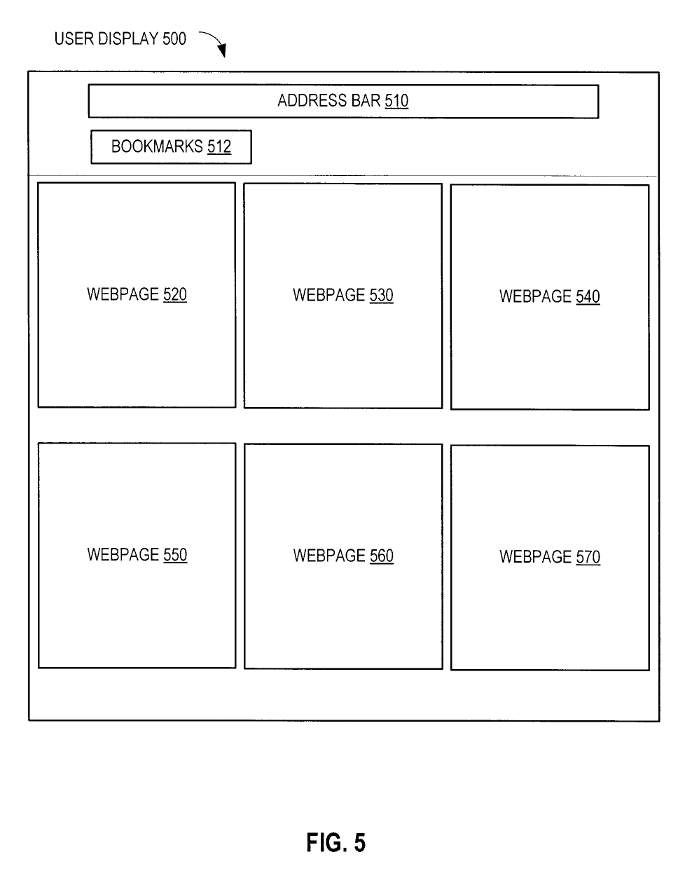

FIG. 5 is a block diagram illustrating a plurality of web pages as widgets in a web browser. In various embodiments, the multiple search results described herein can each be displayed in a separate widget (e.g., widgets 520, 530, 540, 550, 560 and/or 570). Selecting a particular widget might open, for example, a full page view of the website. A widget, as used herein, may refer to any piece of code that can be installed and executed within any separate HTML-based web page by an end user with requiring additional compilation. Widgets may be visually detached from each other and/or from the web browser window(s).

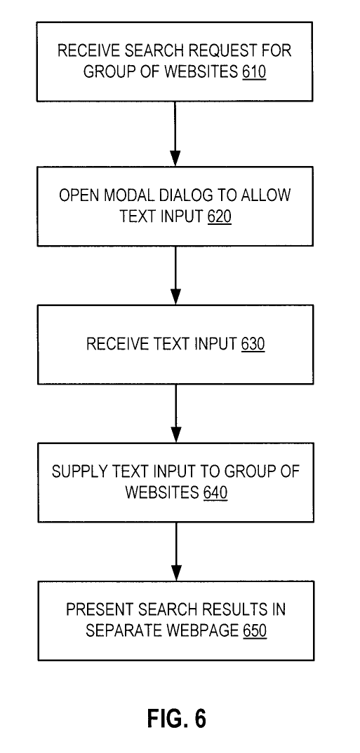

FIG. 6 is a flow diagram illustrating a process for producing search results in a web browser according to various embodiments. A search request is received for a group of websites in a bookmark hierarchy 610. For example, a user may select a bookmark folder having several website links and select to search all of the links in the folder. In response to the search request, a modal dialog is opened to allow text input from the user 620. As discussed herein, the modal dialog can be any box or display that has a field for text entry. The modal dialog can be visually attached to a dropdown menu in the web browser in some embodiments, but it is not necessary that it be visually attached.

Text input is received 630 and the text input is then supplied to each of the websites in the selected group 640. Once each of the websites has generated a search result, the web browser presents each of the search results in a separate web page 650. In some embodiments, the results are presented substantially simultaneously. However, if one or more of the websites has a delay in generating a search result, that result may not be presented until after the other results have been presented on the browser. In some embodiments, the separate results are displayed in separate tabs, as discussed herein. In other embodiments, the separate results are displayed in a cover-flow or as web widgets.

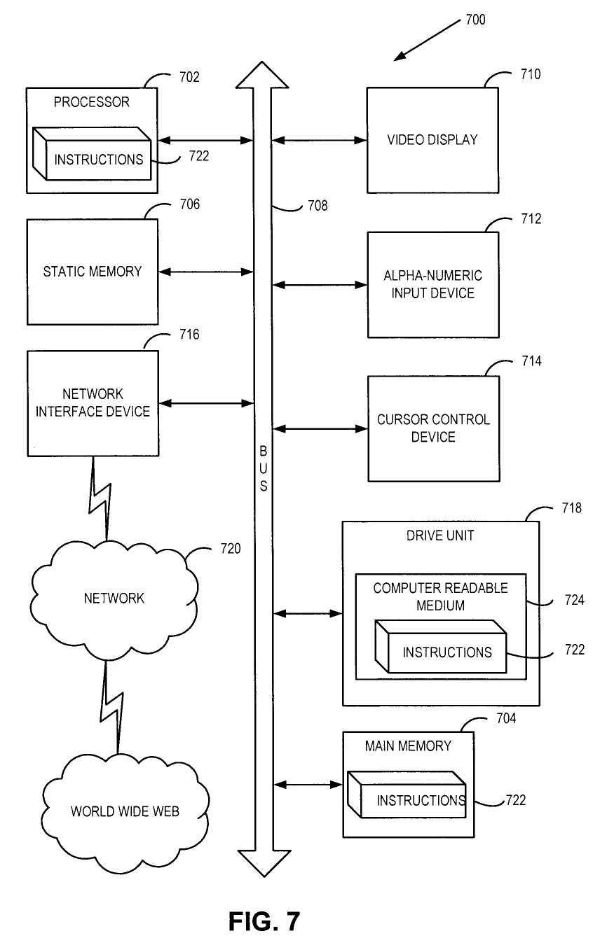

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory 718 (e.g., a data storage device), which communicate with each other via a bus 708.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 722 for performing the operations and steps discussed herein.

The computer system 700 may further include a network interface device 716. The computer system 700 also may include a video display unit 710 (e.g., a liquid crystal display (LCD) or a cathode ray tube (CRT)), an alphanumeric input device 712 (e.g., a keyboard), and a cursor control device 714 (e.g., a mouse)

The secondary memory 718 may include a machine-readable storage medium (or more specifically a computer-readable storage medium) 724 on which is stored one or more sets of instructions (e.g., software 722) embodying any one or more of the methodologies or functions described herein. The software 722 may also reside, completely or at least partially, within the main memory 704 and/or within the processing device 702 during execution thereof by the computer system 700, the main memory 704 and the processing device 702 also constituting machine-readable storage media. The software 722 may further be transmitted or received over a network 720 via the network interface device 716.

While the machine-readable storage medium 724 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine readable storage medium” shall accordingly be taken to include, but not be limited to, solid-state memories, and optical and magnetic media.

Various components described herein may be a means for performing the functions described herein. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a computer readable medium, which provides content that represents instructions that can be executed. The content may result in a computer performing various functions/operations described herein. A computer readable (or machine readable or electronically accessible) medium includes any mechanism that provides (i.e., stores and/or transmits) information in a form accessible by a computing device (e.g., computer, PDA, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or the like. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method, comprising:
receiving input from a user indicating a selection of a hierarchical group of websites from a bookmark hierarchy in a web browser;
opening a modal dialog to allow text input from the user in a response to the selection;
receiving text input via the modal dialog;
supplying the text input to each of the websites in the hierarchical group to cause each website in the group to produce a search result for the text input; and
presenting each of the search results substantially simultaneously in a separate webpage associated with a respective website in the hierarchical group.

2. The method of claim 1, wherein presenting each of the search results in a separate webpage further comprises presenting each webpage in a cover-flow interface.

3. The method of claim 1, wherein presenting each of the search results in a separate webpage further comprises presenting each webpage in one of a different tab, a different window, or a different widget.

4. The method of claim 1, wherein the user selecting the hierarchical group comprises the user selecting the hierarchical group from a dropdown menu on the web browser.

5. The method of claim 4, wherein the opened modal dialog is visually attached to the dropdown menu.

6. The method of claim 4, wherein the opened modal dialog is visually detached from the dropdown menu.

7. The method of claim 1, wherein the hierarchical group is a subgroup of a larger group.

8. A method, comprising:
detecting a text string in a web browser based on user input;
receiving user input identifying a group of websites, each website having at least one input form to allow text input;
providing the text string to the at least one input form for each website in the group; and
presenting the results of each website processing the text string, each result presented substantially simultaneously in a separate webpage.

9. The method of claim 8, wherein the group of websites is a first subgroup in a hierarchical group, the method further comprising:
receiving user input identifying a second subgroup of the hierarchical group;
providing the text string to input forms for each website in the second subgroup;
presenting the processing results of the first subgroup in a first window, each result in a separate tab; and
presenting the processing results of the second subgroup in a second window, each result in a separate tab.

10. An article of manufacture comprising a machine readable storage medium having content to provide instructions to result in a machine performing operations including:
receiving input from a user indicating a selection of a hierarchical group of websites from a bookmark hierarchy in a web browser;
opening a modal dialog to allow text input from the user in a response to the selection;
receiving text input via the modal dialog;
supplying the text input to each of the websites in the hierarchical group to cause each website in the group to produce a search result for the text input; and
presenting each of the search results substantially simultaneously in a separate webpage associated with a respective website in the hierarchical group.

11. The article of manufacture of claim 10, wherein presenting each of the search results in a separate webpage further comprises presenting each webpage in a cover-flow interface.

12. The article of manufacture of claim 10, wherein presenting each of the search results in a separate webpage further comprises presenting each webpage in one of a different tab, a different window, or a different widget.

13. The article of manufacture of claim 10, wherein the user selecting the hierarchical group comprises the user selecting the hierarchical group from a dropdown menu on the web browser.

14. The article of manufacture of claim 13, wherein the opened modal dialog is visually attached to the dropdown menu.

15. The article of manufacture of claim 13, wherein the opened modal dialog is visually detached from the dropdown menu.

16. An apparatus, comprising:
means for receiving input from a user indicating a selection of a hierarchical group of websites from a bookmark hierarchy in a web browser;
means for opening a modal dialog to allow text input from the user in a response to the selection;
means for receiving text input via the modal dialog;
means for supplying the text input to each of the websites in the hierarchical group to cause each website in the group to produce a search result for the text input; and
means for presenting each of the search results substantially simultaneously in a separate webpage associated with a respective website in the hierarchical group.

17. The apparatus of claim 16, wherein the means for presenting each of the search results in a separate webpage further comprises means for presenting each webpage in a cover-flow interface.

18. The apparatus of claim 16, wherein the means for presenting each of the search results in a separate webpage further comprises means for presenting each webpage in one of a different tab, a different window, or a different widget.

19. The apparatus of claim 16, wherein the user selecting the hierarchical group comprises the user selecting the hierarchical group from a dropdown menu on the web browser.

20. The apparatus of claim 19, wherein the opened modal dialog is visually attached to the dropdown menu.

21. The apparatus of claim 19, wherein the opened modal dialog is visually detached from the dropdown menu.

22. The apparatus of claim 19, wherein the hierarchical group is a subgroup of a larger group.

23. An article of manufacture comprising a machine readable storage medium having content to provide instructions to result in a machine performing operations including:
detecting a text string in a web browser based on user input;
receiving user input identifying a group of websites, each website having at least one input form to allow text input;
providing the text string to the at least one input form for each website in the group; and
presenting the results of each website processing the text string, each result presented substantially simultaneously in a separate webpage.

24. The article of manufacture of claim 23, wherein the group of websites is a first subgroup in a hierarchical group and the instructions comprise further instructions to result in a machine performing operations including:
receiving user input identifying a second subgroup of the hierarchical group;
providing the text string to input forms for each website in the second subgroup;
presenting the processing results of the first subgroup in a first window, each result in a separate tab; and
presenting the processing results of the second subgroup in a second window, each result in a separate tab.
